(19) United States
(12) Patent Application Publication
(10) Pub. No.: US 2006/0119560 A1
(43) Pub. Date: Jun. 8, 2006

(54) Clock generating circuit and a display device having the same

(75) Inventor: Jin Jeon, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/272,498

(22) Filed: Nov. 10, 2005

(30) Foreign Application Priority Data
Dec. 2, 2004 (KR) 2004-100553

(51) Int. Cl. G09G 3/36

(52) U.S. Cl. 345/98

(57) ABSTRACT

A clock generating circuit and a display device having the same are provided. An exemplary clock generating circuit includes a first voltage generating part, a second voltage generating part and an intermediate voltage generating part. The first voltage generating part generates a first voltage during a high level period. The second voltage generating part generates a second voltage that is lower than the first voltage during a low level period. The intermediate voltage generating part generates an intermediate voltage that is higher than the second voltage and lower than the first voltage during a first transition period when the second voltage is changed to the first voltage and a second transition period when the first voltage is changed to the second voltage.

### CROSS-REFERENCE TO RELATED APPLICATION

This application claims priority to Korean Patent Application No. 2004-100553, filed on Dec. 2, 2004, the disclosure of which is incorporated by reference herein in its entirety.

### BACKGROUND OF THE INVENTION

1. Technical Field

The present invention relates to a clock generating circuit capable of reducing power consumption and a display device having the clock generating circuit.

2. Discussion of the Related Art

A liquid crystal display (LCD) is one of the most widely used flat panel displays. For example, an LCD is commonly found in a variety of electronic devices such as flat screen televisions, laptop computers, cell phones and digital cameras.

In general, an LCD device includes an LCD panel, a gate driving circuit and a data driving circuit. The LCD panel includes a plurality of pixels arranged in a matrix shape. The LCD panel further includes a plurality of gate lines and a plurality of data lines.

The gate driving circuit applies a gate signal to the gate lines in sequence, the data driving circuit applies a data signal to the data lines in sequence and the LCD panel displays an image in response to the gate signal and the data signal.

The gate driving circuit outputs the gate signal in response to a start signal, a turn-on signal, a turn-off signal and a clock signal applied from another device. For example, the clock signal is generated by a clock generating circuit that outputs a low level signal during a low level period and a high level signal during a high level period. Therefore, the clock signal is either a high level signal or a low level signal.

Total power consumption (Pc) of a conventional clock generating circuit is defined by the following equation 1:

$$Pc = \frac{1}{2} {C ( Δ V )}^{2} \qquad Equation 1$$

where ‘ΔV’ represents a voltage difference between a high voltage and a low voltage.

As shown in equation 1, the total power consumption Pc increases, when the voltage difference ‘ΔV’ increases. However, when the voltage difference ‘ΔV’ is decreased to reduce the power consumption Pc, an amplitude of the clock signal is changed.

A need therefore exists for an apparatus and method for reducing the power consumption of the clock generating circuit without changing the amplitude of the clock signal.

### SUMMARY OF THE INVENTION

The present invention provides a clock generating circuit capable of reducing power consumption and an LCD device having the clock generating circuit.

In one aspect of the invention, the clock generating circuit includes a first voltage generating part, a second voltage generating part and an intermediate voltage generating part.

The first voltage generating part generates a first voltage during a high level period. The second voltage generating part generates a second voltage that is lower than the first voltage during a low level period. The intermediate voltage generating part generates an intermediate voltage that is higher than the second voltage and lower than the first voltage during a first transition period when the second voltage is changed to the first voltage and a second transition period when the first voltage is changed to the second voltage.

In another aspect of the invention, the display device includes a display panel, a first clock generating circuit, a second clock generating circuit, a gate driving circuit and a data driving circuit.

The display panel includes a first substrate having a plurality of pixels arranged in a matrix shape, and a second substrate that faces the first substrate. The display panel displays an image in response to a gate signal and a data signal that are applied to the pixels.

The first clock generating circuit generates a first clock signal having a stepped shape. The second clock generating circuit generates a second clock signal having a stepped shape, and the first and second clock signals have a different phase from each other.

The gate driving circuit applies the gate signal to the pixels in response to the first and second clock signals. The data driving circuit applies the data signal to the pixels.

In yet another aspect of the present invention, a method for generating a clock signal at a clock generating circuit, comprises: generating, at a first voltage part of the clock generating circuit, a first voltage during a high level period; generating, at a second voltage part of the clock generating circuit, a second voltage that is lower than the first voltage during a low level period; generating, at an intermediate voltage generating part of the clock generating circuit, an intermediate voltage that is higher than the second voltage and lower than the first voltage during a first transition period when the second voltage is changed to the first voltage and a second transition period when the first voltage is changed to the second voltage; and generating, at the clock generating circuit, the clock signal in response to a switching signal.

### BRIEF DESCRIPTION OF THE DRAWINGS

The above and other features of the present invention will become more apparent by describing in detail exemplary embodiments thereof with reference to the accompanying drawings wherein:

FIG. 1 is a block diagram showing a clock generating circuit in accordance with an exemplary embodiment of the present invention;

FIG. 2 is an output waveform of the clock generating circuit in FIG. 1;

FIG. 3 is a circuit diagram of the clock generating circuit in FIG. 1;

FIG. 4 is a timing diagram of a first switching signal, a second switching signal, a third switching signal and a fourth switching signal in FIG. 3;

FIG. 5 is a block diagram showing an LCD device in accordance with an exemplary embodiment of the present invention;

FIG. 6 is an input/output waveform of a gate driving circuit in FIG. 5; and

FIG. 7 is a plan view of the LCD device in FIG. 5.

### DESCRIPTION OF EXEMPLARY EMBODIMENTS

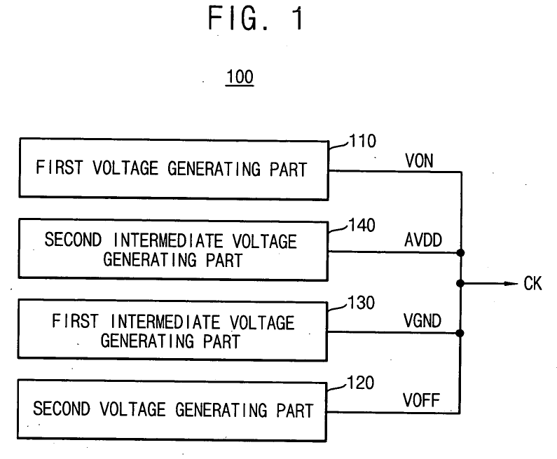

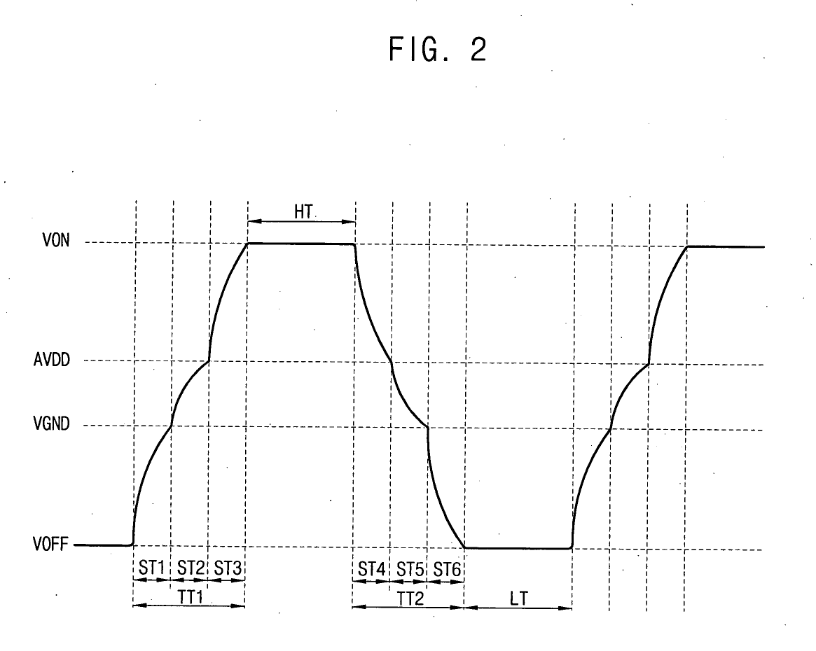

FIG. 1 is a block diagram showing a clock generating circuit 100 in accordance with an exemplary embodiment of the present invention. FIG. 2 is an output waveform of the clock generating circuit 100.

Referring to FIGS. 1 and 2, the clock generating circuit 100 includes a first voltage generating part 110, a second voltage generating part 120, a first intermediate voltage generating part 130 and a second intermediate voltage generating part 140.

The clock generating circuit 100 generates a clock signal CK that has a predetermined period. The clock signal CK includes a high level period HT and a low level period LT. The clock signal CK further includes a first transition period TT1 and a second transition period TT2. During the first transition period TT1, the clock signal CK is changed from a low level to a high level. During the second transition period TT2, the clock signal CK is changed from the high level to the low level.

The first transition period TT1 includes a first sub transition period ST1, a second sub transition period ST2 and a third sub transition period ST3. The second transition period TT2 includes a fourth sub transition period ST4, a fifth sub transition period ST5 and a sixth sub transition period ST6.

In the present embodiment, the first and second transition periods TT1 and TT2 are about 2 μs to about 3 μs and the high and low level periods HT and LT are about 30 μs. In addition, each of the first, second and third sub transition periods ST1, ST2 and ST3 is one third of the first transition period TT1. Further, each of the fourth, fifth and sixth sub transition periods ST4, ST5 and ST6 is one third of the second transition period TT2.

The first voltage generating part 110 generates a first voltage VON during the high level period HT. The second voltage generating part 120 generates a second voltage VOFF during the low level period LT. The second voltage VOFF is lower than the first voltage VON.

The first intermediate voltage generating part 130 generates a first intermediate voltage VGND during the first and fifth sub transition levels ST1 and ST5. The first intermediate voltage VGND is higher than the second voltage VOFF, and lower than the first voltage VON. The second intermediate voltage generating part 140 generates a second intermediate voltage AVDD during the second and fourth sub transition levels ST2 and ST4. The second intermediate voltage is higher than the first intermediate voltage V GND, and lower than the first voltage VON.

As shown in FIG. 2, the clock signal CK is changed from the second voltage VOFF to the first intermediate voltage VGND during the first sub transition period ST1. The clock signal CK is changed from the first intermediate voltage VGND to the second intermediate voltage AVDD during the second sub transition period ST2 and is changed from the second intermediate voltage AVDD to the first voltage VON during the third sub transition period ST3.

In addition, the clock signal CK is changed from the first voltage VON to the second intermediate voltage AVDD during the fourth sub transition period ST4. The clock signal CK is changed from the second intermediate voltage AVDD to the first intermediate voltage VGND during the fifth sub transition period ST5 and is changed from the first intermediate voltage VGND to the second voltage VOFF during the sixth sub transition period ST6.

In the present embodiment, the first voltage VON is in a range from about 15V to about 25V, the second voltage VOFF is in a range from about −5 V to about −15V, the first intermediate voltage VGND is about 0V, and the second intermediate voltage AVDD is in a range from about 5V to about 10V.

Also in the present embodiment, and as indicated below in equation 2, a level difference between the first intermediate voltage VGND and the second intermediate voltage AVDD is defined as ‘1’, a level difference between the second voltage VOFF and the first intermediate voltage VGND is defined as ‘2’, and a level difference between the second intermediate voltage AVDD and the first voltage VON is defined as ‘2’.

Power consumption (Ps) of the clock generating circuit 100 is defined by equation 2:

$$Ps = \frac{1}{2} C [ {( \frac{2}{5} Δ V )}^{2} + {( \frac{1}{5} Δ V )}^{2} + {( \frac{2}{5} Δ V )}^{2} ] = \frac{1}{2} \frac{9}{25} {C ( Δ V )}^{2} \qquad Equation 2$$

where ‘ΔV’ represents a voltage difference between the first voltage VON and the second voltage VOFF.

As shown in equation 2, the power consumption Ps of the clock generating circuit 100 is reduced to be 36% [e.g., ( 9/25)×100] of the power consumption Pc of the conventional clock generating circuit, which is defined in equation 1.

According to the present embodiment, the power consumption Ps is reduced by changing the clock signal CK step by step. In other words, the clock signal CK is changed during the first through sixth sub transition periods ST1-ST6, so that the power consumption Ps is reduced.

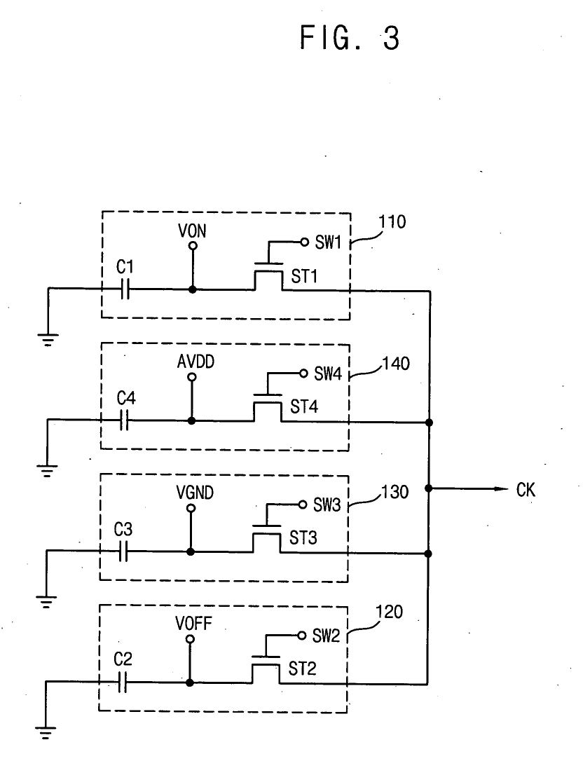

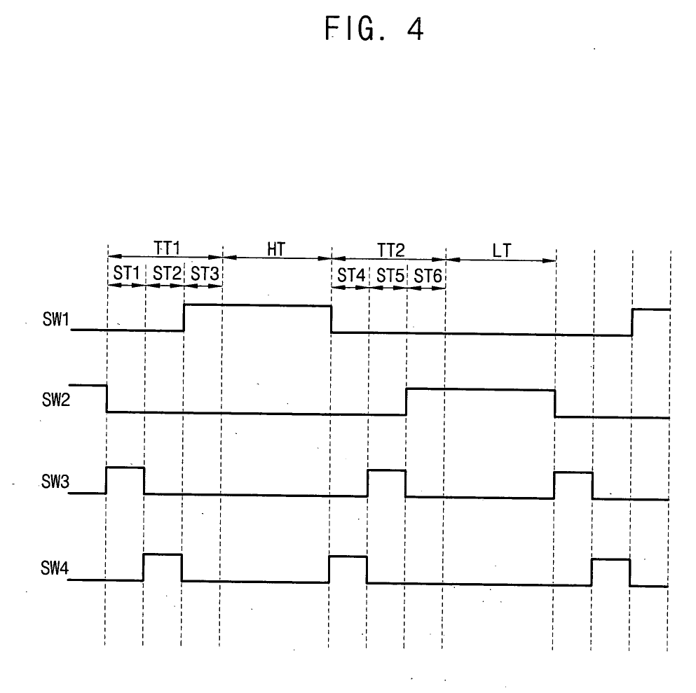

FIG. 3 is a circuit diagram of the clock generating circuit 100. FIG. 4 is a timing diagram of a first switching signal SW1, a second switching signal SW2, a third switching signal SW3 and a fourth switching signal SW4 in FIG. 3.

Referring to FIG. 3, the first voltage generating part 110 includes a first transistor ST1 and a first capacitor C1. The second voltage generating part 120 includes a second transistor ST2 and a second capacitor C2.

The first transistor ST1 includes a first electrode, a second electrode and a third electrode. The first transistor ST1 receives the first switching signal SW1 through the first electrode, and the first voltage VON through the second electrode. The first capacitor C1 includes a first terminal that is electrically connected to the second electrode of the first transistor ST1 and a second terminal that is electrically connected to a ground voltage, so that the first capacitor C1 is electrically charged with the first voltage VON that is provided by another device.

When the first transistor ST1 is turned on in response to the first switching signal SW1, the first voltage VON that is electrically charged at the first capacitor C1 is outputted from the first transistor ST1 through the third electrode.

The second transistor ST2 includes a first electrode, a second electrode and a third electrode. The second transistor ST2 receives the second switching signal SW2 through the first electrode, and the second voltage VOFF through the second electrode. The second capacitor C2 includes a first terminal that is electrically connected to the second electrode of the second transistor ST2, and a second terminal that is electrically connected to the ground voltage, so that the second capacitor C2 is electrically charged with the second voltage VOFF.

When the second transistor ST2 is turned on in response to the second switching signal SW2, the second voltage VOFF that is electrically charged at the second capacitor C2 is outputted from the second transistor ST2 through the third electrode.

As shown in FIG. 4, the first switching signal SW1 is maintained at a high state during the high level period HT and the third sub transition period ST3. Therefore, the first transistor ST1 outputs the first voltage VON during the high level period HT and the third sub transition period ST3.

In addition, the second switching signal SW2 is maintained at a high state during the low level period LT and the sixth sub transition period ST6. Therefore, the second transistor ST2 outputs the second voltage VOFF during the low level period LT and the sixth sub transition period ST6.

Referring to FIG. 3 again, the first intermediate voltage generating part 130 includes a third transistor ST3 and a third capacitor C3. The second intermediate voltage generating part 140 includes a fourth transistor ST4 and a fourth capacitor C4.

The third transistor ST3 includes a first electrode, a second electrode and a third electrode. The third transistor ST3 receives the third switching signal SW3 through the first electrode, and the first intermediate voltage VGND through the second electrode. The third transistor ST3 outputs the first intermediate voltage VGND through the third electrode. The third capacitor C3 includes a first terminal that is electrically connected to the second electrode of the third transistor ST3, and a second terminal that is electrically connected to the ground voltage, so that the third capacitor C3 is electrically charged with the first intermediate voltage VGND.

When the third transistor ST3 is turned on in response to the third switching signal SW3, the first intermediate voltage VGND that is electrically charged at the third capacitor C3 is outputted from the third transistor ST3 through the third electrode.

The fourth transistor ST4 includes a first electrode, a second electrode and a third electrode. The fourth transistor ST4 receives the fourth switching signal SW4 through the first electrode, and the second intermediate voltage AVDD through the second electrode. The fourth transistor ST4 outputs the second intermediate voltage AVDD through the third electrode. The fourth capacitor C4 includes a first terminal that is electrically connected the second electrode of the fourth transistor ST4, and a second terminal that is electrically connected to the ground voltage, so that the fourth capacitor C4 is electrically charged with the second intermediate voltage AVDD.

When the fourth transistor ST4 is turned on in response to the fourth switching signal SW4, the second intermediate voltage AVDD that is electrically charged at the fourth capacitor C4 is outputted from the fourth transistor ST4 through the third electrode.

As shown in FIG. 4, the third switching signal SW3 is maintained at a high state during the first and fifth sub transition periods ST1 and ST5. Therefore, the third transistor ST3 outputs the first intermediate voltage VGND during the first and fifth sub transition periods ST1 and ST5.

In addition, the fourth switching signal SW4 is maintained at a high state during the second and fourth sub transition periods ST2 and ST4. Therefore, the fourth transistor ST4 outputs the second intermediate voltage AVDD during the second and fourth sub transition periods ST2 and ST4.

In the present embodiment, a voltage level of the clock signal CK that is outputted from the clock generating circuit 100 is controlled by the first, second, third and fourth switching signals SW1, SW2, SW3 and SW4. Therefore, the voltage level of the clock signal CK is lowered step by step in sequence by the first voltage VON, the second intermediate voltage AVDD, the first intermediate voltage VGND and the second voltage VOFF. In addition, the clock signal CK is increased step by step in sequence by the second voltage VOFF, the first intermediate voltage VGND, the second intermediate voltage AVDD and the first voltage VON.

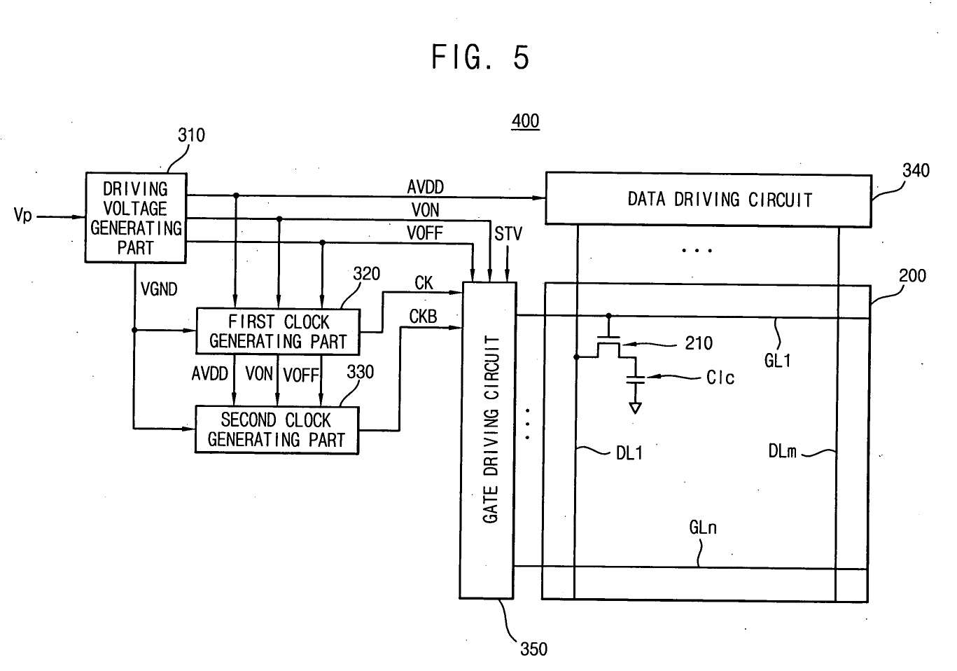

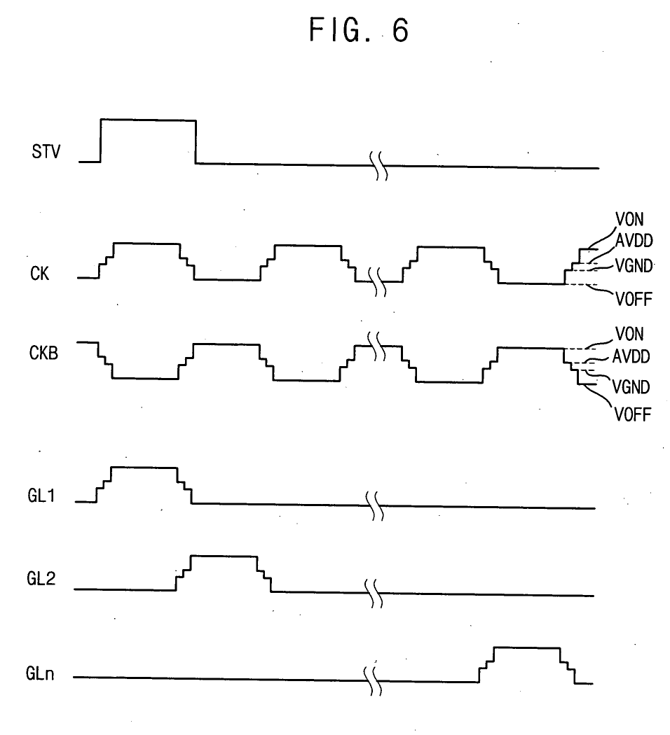

FIG. 5 is a block diagram showing an LCD device 400 in accordance with an exemplary embodiment of the present invention. FIG. 6 is an input/output waveform of a gate driving circuit shown in FIG. 5.

Referring to FIG. 5, the LCD device 400 includes an LCD panel 200, a data driving circuit 340 and a gate driving circuit 350.

The LCD panel 200 includes a plurality of pixels arranged in a matrix shape. Each of the pixels is defined by one of a plurality of gate lines GL1˜GLn and one of a plurality of data lines DL1˜DLn. Each of the pixels includes a thin film transistor 210 and a liquid crystal capacitor Clc. As shown in FIG. 5, a gate electrode of the thin film transistor 210 is electrically connected to a first gate line GL1, a source electrode of the thin film transistor 210 is electrically connected to a first data line DL1, and a drain electrode of the thin film transistor is electrically connected to the liquid crystal capacitor Clc.

The data driving circuit 340 outputs a data signal to the data lines DL1˜DLm in response to the second intermediate voltage AVDD. The gate driving circuit 350 outputs a gate signal in sequence to the gate lines GL1˜GLn in response to a start signal STV, a first voltage VON, a second voltage VOFF, a first clock signal CK and a second clock signal CKB.

As further shown in FIG. 5, the LCD device 400 includes a driving voltage generating part 310, a first clock generating part 320 and a second clock generating part 330.

The driving voltage generating part 310 converts a power voltage Vp into the first voltage VON, the second voltage VOFF, the first intermediate voltage VGND and the second intermediate voltage AVDD. The power voltage Vp is supplied from another device.

The first clock generating part 320 outputs the first clock signal CK in response to the first and second voltages VON and VOFF, and the first and second intermediate voltages VGND and AVDD. The first clock signal CK has a stepped (or stair) shape.

The second clock generating part 330 outputs the second clock signal CKB in response to the first and second voltages VON and VOFF, and the first and second intermediate voltages VGND and AVDD. The second clock signal CKB has a stepped (or stair) shape and a different phase from that of the first clock signal CK.

As shown in FIG. 6, the first and second clock signals CK and CKB are lowered step by step in sequence by the first voltage VON, the second intermediate voltage AVDD, the first intermediate voltage VGND and the second voltage VOFF. In addition, the first and second clock signals CK and CKB are increased step by step in sequence by the second voltage VOFF, the first intermediate voltage VGND, the second intermediate voltage AVDD and the first voltage VON. The first clock signal CK has an inverted phase with respect to the second clock signal CKB. In other words, the first and second clock signals CK and CKB have opposite phases.

Referring back to FIG. 5, the gate driving circuit 350 outputs a gate signal of the first clock signal CK or the second clock signal CKB to the gate lines GL1˜GLn in response to the start signal STV, the first voltage VON and the second voltage VOFF. Therefore, the gate signal has the same stepped shape as that of the first and second clock signals CK and CKB.

According to the present embodiment, each voltage level of the first and second clock signals CK and CKB is changed step by step, so that power consumption of the first and the second clock generating circuits 320 and 330 is reduced. Thus, total power consumption of the LCD device 400 comprising the first and second clock generating circuits 320 and 330 is also reduced.

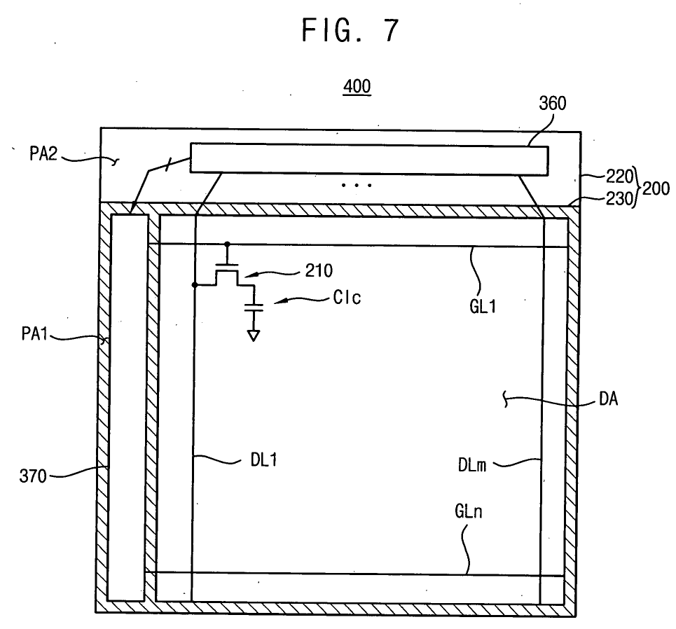

FIG. 7 is a plan view of the LCD device 400.

Referring to FIG. 7, the LCD device 400 includes a first substrate 220, a second substrate 230 and a liquid crystal layer (not shown). The first substrate 220 faces the second substrate 230. The liquid crystal layer is disposed between the first substrate 220 and the second substrate 230.

The LCD panel 200 has a display region DA, a first peripheral region PA1 and a second peripheral region PA2. The first peripheral region PA1 surrounds the display region DA. The second peripheral region PA2 is adjacent to the first peripheral region PA1.

The display region DA of the first substrate 220 includes the plurality of gate lines GL1˜GLn, the plurality of data lines DL1˜DLm, a plurality of the thin film transistors 210 and a pixel electrode (not shown). The display region DA of the second substrate 230 includes a common electrode (not shown) that corresponds to the pixel electrode. The pixel electrode of the first substrate 220, the common electrode of the second substrate 230 and the liquid crystal layer define the liquid crystal capacitor Clc. The display region DA of the second substrate 230 may further include a color filter layer (not shown).

The LCD device 400 further includes a gate driving section 370 and a driving chip 360. The gate driving section 370 is disposed at the first peripheral region PA1 of the first substrate 220 that is adjacent to one end portion of the gate lines GL1˜GLn. The gate driving section 370 is electrically connected to the gate lines GL1˜GLn so that the gate driving section 370 can output a gate signal to the gate lines GL1˜GLn in sequence. The gate driving section 370 is formed at the first peripheral region PA1 by forming the gate lines GL1˜GLn, the data lines DL1˜DLm, the thin film transistors 210 and the pixel electrode at the display region DA of the first substrate 220.

The driving chip 360 is mounted on the second peripheral region PA2 of the first substrate 220. The driving chip 360 may include the driving voltage generating part 310, data driving circuit 340, first clock generating part 320 and second clock generating part 330 as shown in FIG. 5. The driving chip 360 is electrically connected to the gate driving section 370 to apply the start signal STV, the first voltage VON, the second voltage VOFF, the first clock signal CK and the second clock signal CKB thereto. In addition, the driving chip 360 is electrically connected to the data lines DL1˜DLm to apply a data voltage thereto.

Although the driving chip 360 includes the data driving circuit 340, the driving voltage generating part 310, and the first and second clock generating parts 320 and 330, it should be understood by one of ordinary skill in the art that the data driving circuit 340, the driving voltage generating part 310, and the first and second clock generating parts 320 and 330 may be formed as separate chips as shown in FIG. 5 to be electrically connected to the LCD panel 200.

According to an exemplary embodiment of the present invention, a voltage level of the clock generating circuit is gradually changed. Therefore, power consumption of the clock generating circuit and total power consumption of the display device having the clock generating circuit may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A clock generating circuit, comprising:
a first voltage generating part that generates a first voltage during a high level period;
a second voltage generating part that generates a second voltage that is lower than the first voltage during a low level period; and
an intermediate voltage generating part that generates an intermediate voltage that is higher than the second voltage and lower than the first voltage during a first transition period when the second voltage is changed to the first voltage and a second transition period when the first voltage is changed to the second voltage.

2. The circuit of claim 1, wherein the intermediate voltage generating part includes:
a first intermediate voltage generating part and a second intermediate voltage generating part, the first intermediate voltage generating part generating a first intermediate voltage that is higher than the second voltage and lower than the second intermediate voltage, and the second intermediate voltage generating part generating a second intermediate voltage that is higher than the first intermediate voltage and lower than the first voltage.

3. The circuit of claim 2, wherein the first transition period includes:
a first sub transition period, a second sub transition period and a third sub transition period, and the second transition period includes a fourth sub transition period, a fifth sub transition period and a sixth sub transition period, the second voltage is changed to the first intermediate voltage during the first sub transition period, the first intermediate voltage is changed to the second intermediate voltage during the second sub transition period, the second intermediate voltage is changed to the first voltage during the third sub transition period, the first voltage is changed to the second intermediate voltage during the fourth sub transition period, the second intermediate voltage is changed to the first intermediate voltage during the fifth sub transition period, and the first intermediate voltage is changed to the second voltage during the sixth sub transition period.

4. The circuit of claim 3, wherein each of the first, second and third sub transition periods is one third of the first transition period, and each of the fourth, fifth and sixth sub transition periods is one third of the second transition period.

5. The circuit of claim 2, wherein the first voltage is in a range of about 15V to about 25V, the second voltage is in a range of about −5V to about −15V, the first intermediate voltage is about 0V and the second intermediate voltage is in a range of about 5V to about 10V.

6. The circuit of claim 1, wherein the first voltage generating part includes a first switching device that outputs the first voltage in response to a first switching signal during the high level period, and the second voltage generating part includes a second switching device that generates the second voltage in response to a second switching signal during the low level period.

7. The circuit of claim 6, wherein the first voltage generating part further includes a first capacitor that is electrically connected to the first switching device and a ground voltage to be electrically charged with the first voltage, and the second voltage generating part further includes a second capacitor that is electrically connected to the second switching device and the ground voltage to be electrically charged with the second voltage.

8. The circuit of claim 6, wherein the intermediate voltage generating part includes:
a first intermediate voltage generating part and a second intermediate voltage generating part, the first intermediate voltage generating part generating a first intermediate voltage that is higher than the second voltage and lower than the first voltage at a first time point and a fifth time point in the first and second transition periods, respectively in response to a third switching signal, and the second intermediate voltage generating part generating a second intermediate voltage that is higher than the first intermediate voltage and lower than the first voltage at a second time point and a fourth time point in the first and second transition periods, respectively in response to a fourth switching signal.

9. The circuit of claim 8, wherein the first transition period includes:
a first sub transition period, a second sub transition period and a third sub transition period, and the second transition period includes a fourth sub transition period, a fifth sub transition period and a sixth sub transition period, the second voltage is changed to the first intermediate voltage during the first sub transition period, the first intermediate voltage is changed to the second intermediate voltage during the second sub transition period, the second intermediate voltage is changed to the first voltage during the third sub transition period, the first voltage is changed to the second intermediate voltage during the fourth sub transition period, the second intermediate voltage is changed to the first intermediate voltage during the fifth sub transition period, and the first intermediate voltage is changed to the second voltage during the sixth sub transition period.

10. The circuit of claim 9, wherein the first switching signal is maintained at a high state during the high level period and the third sub transition period, and the first switching signal is maintained at a low state during the first, second, fourth, fifth and sixth sub transition periods and the low level period, and the second switching signal is maintained at a high state during the low level period and the sixth sub transition period, and the second switching signal is maintained at a low state during the first, second, third, fourth and fifth sub transition periods and the high level period.

11. The circuit of claim 9, wherein the third switching signal is maintained at a high state during the first and fifth sub transition periods, and the third switching signal is maintained at a low state during the low level period, the high level period, the second, third, fourth and sixth sub transition periods, and the fourth switching signal is maintained at a high state during the second and fourth sub transition periods and is maintained at a low state during the high level period, the low level period the first, third, fifth and sixth sub transition periods.

12. The circuit of claim 8, wherein the first intermediate voltage generating part further includes a third capacitor that is electrically connected to the third switching element and the ground voltage to be electrically charged with the first intermediate voltage, and the second intermediate voltage generating part further includes a fourth capacitor that is electrically connected to the fourth switching element and the ground voltage to be electrically charged with the second intermediate voltage.

13. A display device, comprising:
a display panel that includes a plurality of pixels arranged in a matrix shape, the display panel displaying an image in response to a gate signal and a data signal that are applied to the pixels;
a first clock generating circuit that generates a first clock signal having a stepped shape;
a second clock generating circuit that generates a second clock signal having a stepped shape, the first and second clock signals having a different phase from each other;
a gate driving circuit that applies the gate signal to the pixels in response to the first and second clock signals; and
a data driving circuit that applies the data signal to the pixels.

14. The device of claim 13, wherein each of the first and second clock generating circuits includes:
a first voltage generating part that generates a first voltage during a high level period;
a second voltage generating part that generates a second voltage that is lower than the first voltage during a low level period; and
an intermediate voltage generating part that generates an intermediate voltage that is higher than the second voltage and lower than the first voltage during a first transition period when the second voltage is changed to the first voltage and a second transition period when the first voltage is changed to the second voltage.

15. The device of claim 14, wherein the first and second voltages are applied to the gate driving circuit to operate the gate driving circuit.

16. The device of claim 14, wherein the intermediate voltage generating part includes:
a first intermediate voltage generating part and a second intermediate voltage generating part, the first intermediate voltage generating part generating a first intermediate voltage that is higher than the second voltage and lower than the first voltage during the first and second transition periods, and the second intermediate voltage generating part generating a second intermediate voltage that is higher than the first voltage and lower than the second voltage during the first and second transition periods.

17. The device of claim 16, wherein the second intermediate voltage is applied to the data driving circuit to operate the data driving circuit.

18. The device of claim 16, wherein the first intermediate voltage corresponds to a ground voltage.

19. The device of claim 13, wherein the first clock signal has an inverted phase with respect to the second clock signal.

20. The device of claim 13, wherein the display panel further includes:
a first substrate and a second substrate that faces the first substrate, wherein the pixels and the gate driving circuit are formed on the first substrate.

21. The device of claim 13, further comprising:
a driving voltage generator receiving and converting a power voltage into the first voltage, the second voltage, the first intermediate voltage and the second intermediate voltage and supplying the first voltage, second voltage, and first and second intermediate voltages to the first and second clock generating circuits, the second intermediate voltage to the data driving circuit, and the first and second voltages to the gate driving circuit.

22. A method for generating a clock signal at a clock generating circuit, comprising:
generating, at a first voltage part of the clock generating circuit, a first voltage during a high level period;
generating, at a second voltage part of the clock generating circuit, a second voltage that is lower than the first voltage during a low level period;
generating, at an intermediate voltage generating part of the clock generating circuit, an intermediate voltage that is higher than the second voltage and lower than the first voltage during a first transition period when the second voltage is changed to the first voltage and a second transition period when the first voltage is changed to the second voltage; and
generating, at the clock generating circuit, the clock signal in response to a switching signal.
